(19) United States
(12) Patent Application Publication
(10) Pub. No.: US 2022/0021809 A1
(43) Pub. Date: Jan. 20, 2022

(54) REDUCING DROPPED FRAMES IN IMAGE CAPTURING DEVICES

(71) Applicant: QUALCOMM Incorporated, San Diego, CA (US)

(72) Inventors: Nitin Srivastava, Hyderabad (IN); Prakasha Nayak, Bangalore (IN); Alok Kumar Pandey, Hyderabad (IN)

(21) Appl. No.: 16/928,750

(22) Filed: Jul. 14, 2020

(51) Int. Cl. H04N 5/232; H04N 19/65

(52) U.S. Cl. CPC H04N 5/23232; H04N 19/65

(57) ABSTRACT

Methods, systems, and devices for reducing dropped frames in image capturing devices are described. The method includes receiving, from an optical sensor of the image capturing device, a batch of frames, determining, by a hardware layer or a software layer of the image capturing device, that an error condition exists in relation to the batch of frames, determining, by the hardware layer, a numerical quantity of frames of the batch of frames in a frame buffer based on determining the error condition exists, and sending, by the hardware layer, the determined quantity of frames to the software layer of the image capturing device for processing by the software layer.

### BACKGROUND

The following relates generally to graphics processing, and more specifically to reducing dropped frames in image capturing devices.

Devices, such as smartphones, tablets, home security systems, automobiles, drones, aircrafts, etc. are widely deployed to collect various types of information, such as visual information. These devices may be configured with optical instruments that are configured to capture the visual information in the form of images or video, which may be stored locally or remotely. In some examples, an optical instrument may be an image sensor configured to capture visual information using photosensitive elements, which may be tunable for sensitivity to a visible spectrum of electromagnetic radiation. In some cases, to support in capturing the visual information, these devices may be configured with light sources that may illuminate target objects or target areas in a physical environment.

In some cases, when an error occurs with an optical instrument, frames that are captured by the optical instrument may be discarded, resulting in a poor user experience. Such devices may benefit from improved techniques in handling errors.

### SUMMARY

The described techniques relate to improved methods, systems, devices, and apparatuses that support reducing dropped frames in image capturing devices. Generally, the described techniques provide for an image capturing device receiving a batch of frames as they are captured by an optical sensor. In some cases, the image capturing device may buffer each frame from the batch of frames as each captured frame is provided by the optical sensor. In some examples, the image capturing device may determine, by a hardware layer or a software layer of the image capturing device, that an error condition exists in relation to the batch of frames. When the image capturing device determines the error condition exists, the image capturing device may determine, by the hardware layer, how many frames of the batch of frames are currently saved in the frame buffer. The image capturing device may then send, by the hardware layer, the determined quantity of frames to the software layer of the image capturing device for processing by the software layer.

A method of reducing dropped frames in an image capturing device, the method including is described. The method may include receiving, from an optical sensor of the image capturing device, a batch of frames, determining, by a hardware layer or a software layer of the image capturing device, that an error condition exists in relation to the batch of frames, determining, by the hardware layer, a numerical quantity of frames of the batch of frames in a frame buffer based on determining the error condition exists, and sending, by the hardware layer, the determined quantity of frames to the software layer of the image capturing device for processing by the software layer.

An apparatus for reducing dropped frames in an image capturing device, the method including is described. The apparatus may include a processor, memory coupled with the processor, and instructions stored in the memory. The instructions may be executable by the processor to cause the apparatus to receive, from an optical sensor of the image capturing device, a batch of frames, determine, by a hardware layer or a software layer of the image capturing device, that an error condition exists in relation to the batch of frames, determine, by the hardware layer, a numerical quantity of frames of the batch of frames in a frame buffer based on determining the error condition exists, and send, by the hardware layer, the determined quantity of frames to the software layer of the image capturing device for processing by the software layer.

Another apparatus for reducing dropped frames in an image capturing device, the method including is described. The apparatus may include means for receiving, from an optical sensor of the image capturing device, a batch of frames, determining, by a hardware layer or a software layer of the image capturing device, that an error condition exists in relation to the batch of frames, determining, by the hardware layer, a numerical quantity of frames of the batch of frames in a frame buffer based on determining the error condition exists, and sending, by the hardware layer, the determined quantity of frames to the software layer of the image capturing device for processing by the software layer.

A non-transitory computer-readable medium storing code for reducing dropped frames in an image capturing device, the method including is described. The code may include instructions executable by a processor to receive, from an optical sensor of the image capturing device, a batch of frames, determine, by a hardware layer or a software layer of the image capturing device, that an error condition exists in relation to the batch of frames, determine, by the hardware layer, a numerical quantity of frames of the batch of frames in a frame buffer based on determining the error condition exists, and send, by the hardware layer, the determined quantity of frames to the software layer of the image capturing device for processing by the software layer.

Some examples of the method, apparatuses, and non-transitory computer-readable medium described herein may further include operations, features, means, or instructions for determining a frame of the batch of frames may be buffered in the frame buffer, and incrementing a counter of the image capturing device based on the frame being buffered in the frame buffer, where the counter indicates a quantity of frames buffered in the frame buffer since initiating the batch of frames.

In some examples of the method, apparatuses, and non-transitory computer-readable medium described herein, determining the quantity of frames may include operations, features, means, or instructions for determining a count value of the counter based on determining the hardware error exists in the hardware layer or determining the software error exists in the software layer, or both.

In some examples of the method, apparatuses, and non-transitory computer-readable medium described herein, the initiating of the batch of frames may be indicated by a start of frames indicator for the batch of frames. In some examples of the method, apparatuses, and non-transitory computer-readable medium described herein, the counter includes a dedicated hardware register.

In some examples of the method, apparatuses, and non-transitory computer-readable medium described herein, determining the error condition exists may include operations, features, means, or instructions for detecting an absence of a batch complete message for the batch of frames before a start of frames indicator for a second batch of frames may be detected, where the batch of frames may be a first batch of frames, and where the second batch of frames may be directly subsequent to the batch of frames.

In some examples of the method, apparatuses, and non-transitory computer-readable medium described herein, determining the quantity of frames may include operations, features, means, or instructions for determining a count value of the counter of the image capturing device based on detecting the absence of the batch complete message for the batch of frames before detecting the start of frames indicator for the second batch of frames.

In some examples of the method, apparatuses, and non-transitory computer-readable medium described herein, sending the determined quantity of frames to the software layer may include operations, features, means, or instructions for determining a range of addresses for frames associated with the numerical quantity of frames of the batch of frames in the frame buffer or an address for each frame associated with the numerical quantity of frames of the batch of frames in the frame buffer, and providing the range of addresses for the frames or the address for each frame to the software layer.

In some examples of the method, apparatuses, and non-transitory computer-readable medium described herein, a frame rate of the image capturing device includes at least 60 frames per second (e.g., 60 frames per second, or 90 frames per second, or 120 frames per second, or 240 frames per second, or 480 frames per second, or 720 frames per second, or 960 frames per second, or any combination thereof).

In some examples of the method, apparatuses, and non-transitory computer-readable medium described herein, the hardware layer includes at least one of the optical sensor, or an image sensor, or an image processor, or an image signal processor, or a device memory, or the frame buffer, or a data storage device, or a system memory management unit, or a hardware video encoder, or a hardware video decoder, or a display device, or any combination thereof.

In some examples of the method, apparatuses, and non-transitory computer-readable medium described herein, the software layer including at least one of a software video encoder, or a software video decoder, or an operating system, or a software application, or an image processing algorithm, or a system process, or any combination thereof.

In some examples of the method, apparatuses, and non-transitory computer-readable medium described herein, determining the error condition exists may include operations, features, means, or instructions for determining a hardware error exists in the hardware layer or a software error exists in the software layer, or any combination thereof.

### BRIEF DESCRIPTION OF THE DRAWINGS

FIG. 1 illustrates an example of a system for reducing dropped frames in an image capturing device that supports reducing dropped frames in image capturing devices in accordance with aspects of the present disclosure.

FIG. 2 illustrates an example of an environment that supports reducing dropped frames in image capturing devices in accordance with aspects of the present disclosure.

FIG. 3 illustrates an example of a process flow that supports reducing dropped frames in image capturing devices in accordance with aspects of the present disclosure.

FIGS. 4 and 5 show block diagrams of devices that support reducing dropped frames in image capturing devices in accordance with aspects of the present disclosure.

FIG. 6 shows a block diagram of an image processing manager that supports reducing dropped frames in image capturing devices in accordance with aspects of the present disclosure.

FIG. 7 shows a diagram of a system including a device that supports reducing dropped frames in image capturing devices in accordance with aspects of the present disclosure.

FIGS. 8 and 9 show flowcharts illustrating methods that support reducing dropped frames in image capturing devices in accordance with aspects of the present disclosure.

### DETAILED DESCRIPTION

High frame rate (HFR) relates to images captured by a camera at a frame rate higher than a standard frame rate (e.g., 24 frames per second (fps)), where each frame is an image captured by an image sensor. A high speed camera may include a device configured to capture images with exposures of less than 1/1,000th of a second or frame rates in excess of 240 frames per second. As the number of frames per second increases in HFR, the motion becomes smoother and reduces motion blur and lag, and enables content to be played back smoothly in slow motion based on the relatively high number of images captured per second.

In some examples, a hardware layer of an HFR system (e.g., HFR image capturing devices, HFR cameras, etc.) may buffer a set number of frames in batches of frames (e.g., buffering a batch of 2 frames, 4 frames, 8 frames, 12 frames, 16 frames, etc.). In some cases, the number of frames in a batch may be based on the frames per second implemented by the HFR system. In one example, 60 fps or 120 fps may be associated with a batch of 2 frames, 240 fps may be associated with a batch of 4 frames, 480 fps may be associated with a batch of 8 frames, 960 fps may be associated with a batch of 12 frames or 16 frames, and so forth. In some cases, other associations between fps and frames per batch may be used (e.g., 240 fps may be associated with a batch of more or less than 4 frames, 480 fps may be associated with a batch of more or less than 8 frames, 960 fps may be associated with a batch of more or less than 12 frames, etc.).

In some examples, the hardware layer may notify a software layer of the HFR system that a batch of frames are ready for processing. When processing frames in batches, the hardware layer may send a single interrupt to the software layer indicating a batch of frames is ready for processing instead of sending an interrupt for each frame as it is buffered. In some examples, the HFR system may send a consolidated batch complete message (e.g., the single interrupt) to the software layer that indicates a batch of frames are ready for processing.

In some cases, the HFR system may experience an error condition (e.g., the hardware layer enters a bad state, the software layer enters a bad state, etc.). Examples of error conditions may include hardware error conditions (e.g., hardware timeout, overheating, component failure, buffer overflow, etc.) or software error conditions (e.g., page faults, unmap errors, permission issues, missing command errors, grammatical errors, error handling errors, calculation errors, control flow errors, etc.). In some cases, a user may cause a hardware error condition or a software error condition, or both. Examples of user-caused errors may include a user closing an application of the image capturing device, a user powering off the image capturing device, a user switching from a first device mode to a second device mode (e.g., switching from a video mode to a camera mode, switching from an imaging mode to a settings mode, switching from a high frame rate mode to a non-high frame rate mode), etc.), or any combination thereof.

When an error condition occurs, the software layer may not receive a batch complete message from the hardware layer (e.g., hardware layer delays batch complete message, hardware layer does not send the batch complete message, software layer unable to receive batch complete message). The software layer not receiving a batch complete message from the hardware layer may lead to an FPS mismatch. As a result, the currently buffered frames may be dropped (e.g., dropped frames), which results in a decrease in the quality of the user experience.

The described techniques include a hardware layer of the HFR system sending buffered frames to the software layer based on conditions monitored by the hardware layer. In some examples, the hardware layer may include a counter that is associated with frames being added to a frame buffer. The hardware layer may increment the counter each time a frame captured by the image sensor is added to the frame buffer. Thus, the counter may indicate a quantity of frames currently buffered in the frame buffer since initiating a current batch of frames. In some examples, the initiating of the batch of frames may be indicated by a start of frames indicator. The hardware layer may zero the counter based on the start of frames indicator (e.g., each time a new batch of frames is indicated by the start of frames indicator).

In some examples, the hardware layer may detect an error in the hardware layer or the software layer. The hardware layer may determine a current value X (e.g., an integer, or positive integer or zero) in the counter in response to detecting the error or being informed of the error (e.g., software layer informing the hardware layer of a software-related error). The hardware layer may send the X frames in the buffer to the software layer based on the hardware layer determining there are X number of frames in the buffer as indicated by the counter. In one example, a buffer may be configured to hold up to 8 frames and the hardware layer may increment the counter each time a frame is added to the buffer. When the hardware layer detects the error the hardware layer may determine that the current value of the counter is 6, indicating 6 of the current batch of 8 frames has successfully been saved to the frame buffer before the error was detected, at the time the error was detected, or after detecting the error. Accordingly, the hardware layer may send the 6 frames in the frame buffer to the software layer. In some cases, the hardware layer sending the 6 frames in the frame buffer to the software layer may include the hardware layer determining an address or range of addresses (e.g., memory addresses of the frame buffer) for each of the 6 frames, a range of addresses for two or more of the 6 frames, etc., and the hardware layer providing to the software layer the range of addresses for the frames or the address for each of the 6 frames.

In some examples, the hardware layer may monitor a start of frames indicator and send buffered frames to the software layer based on the start of frames indicator. The hardware layer may detect a first start of frames indicator for a first batch of frames. The hardware layer may track the number of frames of the first batch of frames as they are buffered. The hardware layer may send a batch complete message to the software layer when the hardware layer determines the last frame from the first batch of frames is buffered. The hardware layer may then detect a start of frames indicator for a second batch of frames. After the hardware layer detects the start of frames indicator for the second batch of frames the hardware layer may track the number of frames of the second batch of frames as they are buffered. The hardware layer may then detect a start of frames indicator for a third batch of frames before a batch complete message for the second batch of frames is sent to the software layer. When the hardware layer determines that the start of frames indicator is received for the third batch of frames, but the batch complete message for the second batch of frames has not been sent (e.g., by a subsystem of the hardware layer, etc.), the hardware layer may send the frames of the second batch currently residing in the frame buffer to the software layer (e.g., all 8 frames of an 8 frame buffer). Accordingly, the described techniques maintain a current frame rate and avoid frames being dropped in an HFR system when errors occur, resulting in an improved visual experience for end users.

Aspects of the disclosure are initially described in the context of a multimedia system. Aspects of the disclosure are further illustrated by and described with reference to an environment of a multimedia system. Aspects of the disclosure are further illustrated by and described with reference to a process flow of a multimedia system. Aspects of the disclosure are further illustrated by and described with reference to apparatus diagrams, system diagrams, and flowcharts that relate to reducing dropped frames in image capturing devices.

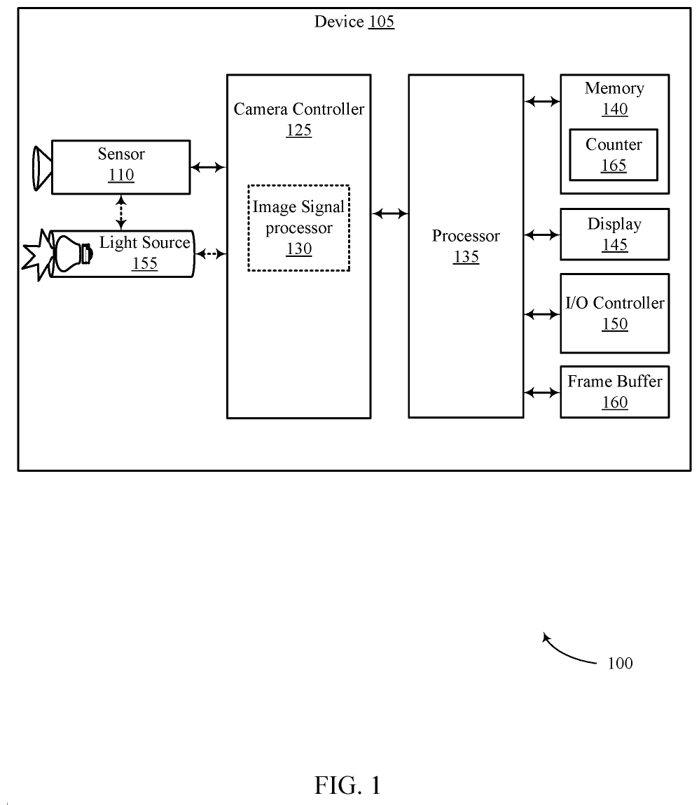

FIG. 1 illustrates an example of a device architecture 100 that supports reducing dropped frames in image capturing devices in accordance with aspects of the present disclosure. The device architecture 100 may illustrate an example design of a device 105, which may refer to any device configured with a camera, an image sensor, a light sensor, etc. In some cases, the device 105 may refer to a camera-enabled device, a standalone camera, a non-standalone camera, a mobile device, a wireless device, a remote device, a handheld device, a subscriber device, a personal electronic device such as a cellular phone, a personal digital assistant (PDA), a tablet computer, a laptop computer, a personal computer, or some other suitable terminology. Further examples of devices that may implement one or more aspects of reducing dropped frames in image capturing devices may include camcorders, webcams, computer monitors, drones, cockpit controls and/or displays, camera view displays (such as the display of a rear-view camera in a vehicle), etc. The term “device” is not limited to one or a specific number of physical objects (such as one smartphone). As used herein, a device 105 may be any electronic device with multiple parts that may implement at least some portions of the present disclosure to implement one or more aspects of reducing dropped frames in image capturing devices. While the described techniques and examples use the term “device” to describe various aspects of the present disclosure, the term “device” is not limited to a specific software or hardware configuration, type, or number of objects.

In the example of FIG. 1, the device 105 may be configured to capture, store, and/or communicate (e.g., broadcast, stream, transmit, receive) visual information to implement one or more aspects of reducing dropped frames in image capturing devices. For example, the device 105 may be configured with a sensor 110, a camera controller 125, a processor 135, a memory 140, a display 145, and an I/O controller 150, to capture, store, and/or communicate the visual information. Although, the device 105 illustrates the sensor 110, the camera controller 125, the processor 135, the memory 140, the display 145, and the I/O controller 150, the present disclosure may apply to any device architecture having one or more sensors, camera controllers, processors, memories, displays, and I/O controllers. In the example of FIG. 1, one or more of the sensor 110, the camera controller 125, the processor 135, the memory 140, the display 145, and the I/O controller 150 may support reducing dropped frames in image capturing devices. The device 105 may also include additional features or components not shown. For example, the device 105 may be configured with a wireless interface, which may include a number of transceivers and a baseband processor to support wireless communications.

The sensor 110 may be coupled to and/or in electronic communication with the camera controller 125, an image signal processor 130 (e.g., some image signal processor and/or image signal processing software), and the processor 135 (e.g., a general processor of the device 105). In some cases, the sensor 110 may be coupled to and/or in electronic communication with the camera controller 125, and the camera controller 125 may be coupled to and/or in electronic communication with the image signal processor 130 and/or the processor 135. In some examples, the camera controller 125, the image signal processor 130, and/or the processor 135 may be implemented on a single substrate or system on chip (SoC), or may be separately located within a footprint of the device 105.

In some examples, the sensor 110 may be a camera, an image sensor, etc. that outputs a signal, or information bits, indicative of light (e.g., reflective light characteristics of a scene, a light emitted from the scene, an amount or intensity of light associated with the scene, red green blue (RGB) values associated with the scene). For example, the sensor 110 may include a lens (e.g., to capture or focus incoming light), a color filter array (CFA) (e.g., to filter the incoming light according to different individual filter elements of the CFA), a pixel sensor array (e.g., to detect or measure the filtered light), and/or other hardware or components for capturing such light or visual information. The sensor 110 may signal or pass information collected to other components of the device 105 (e.g., the camera controller 125, the image signal processor 130, the processor 135). In some cases, the device 105 may be configured with multiple sensors, such a primary camera or a main camera, and an additional sensor that may be an auxiliary camera.

In some cases, the sensor 110 may refer to a complementary metal oxide semiconductor (CMOS) image sensor, a charge-coupled device (CCD), etc. used in digital imaging applications to capture images (e.g., scenes, target objects within some scene, etc.). In some examples, the sensor 110 may include an array of sensors (e.g., a pixel sensor array). Each sensor in the pixel sensor array may include at least one photosensitive element for outputting a signal having a magnitude proportional to the intensity of incident light or radiation contacting the photosensitive element. When exposed to incident light reflected or emitted from a scene, each sensor in the pixel sensor array may output a signal having a magnitude corresponding to an intensity of light at one point in the scene (e.g., at an image capture time). The signals output from each photosensitive element may be processed (e.g., by the camera controller 125, the image signal processor 130, and/or the processor 135) to form an image or video representing the captured scene.

A pixel brightness measurement or a pixel value from the sensor 110 (e.g., from a pixel sensor array) may correspond to a pixel intensity value, RGB values of a pixel, infrared values of a pixel, or any other parameter associated with light (e.g., or the image being captured, the picture being taken). In some examples, a pixel sensor array may include one or more photosensitive elements for measuring such information. In some examples, the photosensitive elements may have a sensitivity to a spectrum of electromagnetic radiation (e.g., including the visible spectrum of electromagnetic radiation, infrared spectrum of electromagnetic radiation). For example, the at least one photosensitive element may be tuned for sensitivity to a visible spectrum of electromagnetic radiation (e.g., by way of depth of a photodiode depletion region associated with the photosensitive element).

The sensor 110 may, in some cases, be configured with a lens, a color filter array, a pixel sensor array, and/or other hardware which may collect (e.g., focus), filter, and detect lighting information. The lighting information may be passed to the camera controller 125 (e.g., for processing and reconstruction of a raw image data by the image signal processor 130). The image signal processor 130 (e.g., one or more driver circuits for performing image processing operations) may process the lighting information collected by the sensor 110 (e.g., to reconstruct or restore a captured image or video of a scene). In some examples, the processed information (e.g., determined or output from the camera controller 125, the image signal processor 130, and/or the processor 135) may be passed to the display 145 of the device 105. For example, the display 145 may output a representation of the captured image or video of the scene. In other examples, the processed information may be stored by the device 105, or passed to another device, etc. The camera controller 125 may include one or more driver circuits for controlling the sensor 110 (e.g., driver circuits for configuring settings of the sensor 110, for configuring flash settings for a light source 155, etc.).

In some examples, the sensor 110 may be capable of capturing individual image frames (such as still images) and/or capturing video (such as a succession of captured image frames). In some cases, the sensor 110 may itself include one or more image sensors or pixel arrays (not shown for simplicity) and shutters for capturing an image frame and providing the captured image frame to the camera controller 125. The memory 140 may be a non-transient or non-transitory computer readable medium storing computer executable instructions to perform all or a portion of one or more operations described in the present disclosure. In some cases, the device 105 may also include a power supply, which may be coupled to or integrated into the device 105.

As shown, the memory 140 may include counter 165. In some examples, counter 165 may be associated with frames being added to a frame buffer (e.g., frame buffer 160). In some cases, processor 135 or camera controller 125 (via processor 135) may add frames captured by sensor 110 to the frame buffer 160. In some examples, processor 135 or camera controller 125 (via processor 135) may increment the counter 165 each time a frame captured by sensor 110 is added to the frame buffer 160. Thus, the counter 165 may indicate a quantity of frames currently buffered in the frame buffer 160 since initiating a current batch of frames. In some examples, the initiating of the batch of frames may be indicated by a start of frames indicator generated by camera controller 125. In some cases, processor 135 or camera controller 125 (via processor 135) may zero the counter 165 based on the start of frames indicator (e.g., each time a new batch of frames is indicated by the start of frames indicator).

The processor 135 may be one or more suitable processors capable of executing scripts or instructions of one or more software programs (such as instructions) stored within the memory 140. In some aspects, the processor 135 may be one or more general purpose processors that execute instructions to cause the device 105 to perform any number of functions or operations. In additional or alternative aspects, the processor 135 may include integrated circuits or other hardware to perform functions or operations without the use of software. While shown to be coupled to each other via the processor 135 in the example of FIG. 1, the processor 135, memory 140, the camera controller 125, the display 145, and the I/O controller 150 may be coupled to one another in various arrangements. For example, the processor 135, the memory 140, the camera controller 125, the display 145, and/or the I/O controller 150 may be coupled to each other via one or more local buses (not shown for simplicity).

The display 145 may represent a unit capable of displaying video, images, text or any other type of visual information for consumption by a viewer. The display 145 may include a liquid-crystal display (LCD), a LED display, an organic LED (OLED), an active-matrix OLED (AMOLED), or the like. In some cases, display 145 and the I/O controller 150 may be or represent aspects of a same component (e.g., a touchscreen) of the device 105. The display 145 may be configured to display images captured via the sensor 110. In some cases, the display 145 may be configured to display one or more regions of a captured image selected by an individual, via an input (e.g., touch, gesture). The display 145 may thus be any suitable display or screen allowing for user interaction and/or allowing for presentation of information (such as captured images and video) for viewing by a user. In some aspects, the display 145 may be a touch-sensitive display. The I/O controller 150 may be or may include any suitable mechanism, interface, or device to receive input (such as commands) from the user and to provide output to the user. For example, the I/O controller 150 may include (but are not limited to) a graphical user interface, keyboard, mouse, microphone and speakers, and so on.

The camera controller 125 may include the image signal processor 130, which may be one or more image signal processors to process captured image frames or video provided by the sensor 110. In some example implementations, the camera controller 125 (such as image signal processor 130) may control operation of the sensor 110. For example, the camera controller 125 may configure the sensor 110 with a focal length, capture rate, resolution, color palette (such as color versus black and white), a field of view, etc. While described herein with respect to a device including a single sensor 110 (e.g., one camera), aspects of the present disclosure are applicable to any number of sensors, cameras, camera configurations, etc., and are therefore not limited to a single sensor 110. In some aspects, the image signal processor 130 may execute instructions from a memory (such as instructions from the memory 140 or instructions stored in a separate memory coupled to the image signal processor 130) to control operation of the sensor 110. In other aspects, the camera controller 125 may include specific hardware to control operation of the sensor 110. The camera controller 125 and/or image signal processor 130 may, alternatively or additionally, include a combination of specific hardware and the ability to execute software instructions.

As discussed herein, the sensor 110 may capture visual information using one or more photosensitive elements that may be tuned for sensitivity to a visible spectrum of electromagnetic radiation. In some examples, the device 105 may capture an image (e.g., visual information) in dark environments or scenarios where the natural illumination of a scene or image being captured provides for inadequate light in a visible spectrum of electromagnetic radiation being captured by the sensor 110. In some cases, the device 105 may utilize a flash using the light source 155 to illuminate a scene or object being captured (e.g., and the sensor 110 may capture visual information aided via the flash from the light source 155).

Techniques described with reference to aspects of the device 105 are done so for exemplary purposes, and are not intended to be limiting in terms of the applicability of the described techniques. That is, the techniques described may be implemented in, or applicable to, other devices, without departing from the scope of the present disclosure.

The techniques described herein may provide multiple improvements in high frame rate image capturing devices. The benefits of the techniques described herein include maintaining a current frame rate and avoiding frames being dropped in HFR systems, resulting in an improved visual experience for end users. Furthermore, the techniques described herein may provide benefits and enhancements to the operation of the devices 105 (e.g., improved image capture, more accurate image generation, etc., based on operations of the techniques described herein). For example, by maintaining a current frame rate and avoiding dropped frames, the operational characteristics, such as power consumption, processor utilization (e.g., DSP, CPU, GPU, ISP processing utilization), and memory usage of the device 105 may be reduced (e.g., reduced latency associated with tuning or calibration of the sensor 110 settings for image capture operations). The techniques described herein may also improve efficiency in the devices 105 by reducing latency associated with processes related to high frame rate image capturing devices. Also, avoiding dropped frames improves system efficiency because the energy expended by HFR systems in capturing and processing frames that otherwise would be dropped, were it not for the techniques described herein, is preserved.

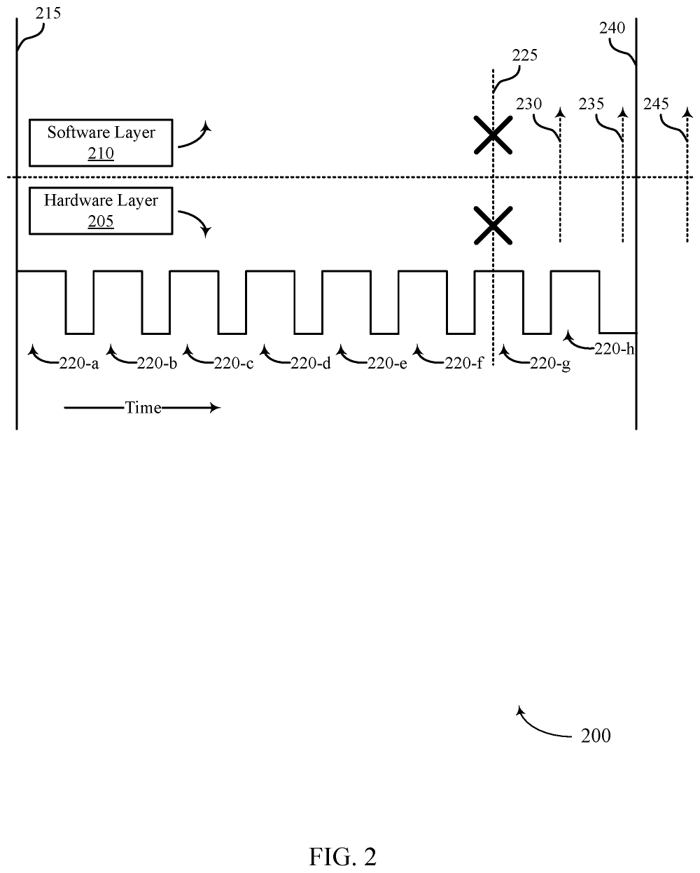

FIG. 2 illustrates an example of an environment 200 that supports reducing dropped frames in image capturing devices in accordance with aspects of the present disclosure. In some examples, environment 200 may implement aspects of device architecture 100. In some cases, environment 200 depicts frames captured by an image sensor (e.g., sensor 110) being buffered in a frame buffer (e.g., frame buffer 160).

In the illustrated example, environment 200 may include a hardware layer 205 and a software layer 210. Examples of the hardware layer 205 include at least one of an optical sensor, or an image sensor, or an image processor, or an image signal processor, or a device memory, or the frame buffer, or a data storage device, or a system memory management unit, or a hardware video encoder, or a hardware video decoder, or a display device, or any combination thereof. Examples of the software layer include at least one of a software video encoder, or a software video decoder, or an operating system, or a software application, or an image processing algorithm, or a system process, or any combination thereof. As illustrated, the environment 200 may be based on a complete batch of frames including 8 frames. In other examples, environment 200 may be based on a complete batch of frames having less or more than 8 frames.

In some examples, the hardware layer 205 may detect a start of frames indicator 215 associated with a batch of frames. The hardware layer 205 may detect captured frames of the batch of frames and buffer the detected frames. As illustrated, at 220-a the hardware layer 205 may detect a first captured frame and buffer the detected first frame, at 220-b detect a second captured frame and buffer the detected second frame, at 220-c detect a third captured frame and buffer the detected third frame, at 220-d detect a fourth captured frame and buffer the detected fourth frame, at 220-e detect a fifth captured frame and buffer the detected fifth frame, and at 220-f detect a sixth captured frame and buffer the detected sixth frame. Each time the hardware layer 205 buffers a captured frame in a frame buffer (e.g., frame buffer 160) the hardware layer 205 may increment a counter (e.g., counter 165). However, in relation to a seventh captured frame at 220-g, the hardware layer 205 may detect an error at 225. The detected error may be a hardware error of the hardware layer 205 or a software-related error of the software layer 210. The hardware layer 205 may detect the error at 225 before the seventh captured frame is captured, while the seventh captured frame is being captured, after the seventh captured frame is captured, before the seventh captured frame is buffered, while the seventh captured frame is being captured, or after the seventh captured frame is captured.

When the hardware layer 205 detects the error at 225, the hardware layer 205 determines the number of frames currently buffered in the frame buffer. If the hardware layer 205 buffers the seventh frame at 220-g in relation to the error detected at 225, then the counter reads 7 (e.g., 7 buffered frames). But if the hardware layer 205 does not buffer the seventh frame at 220-g in relation to the error detected at 225, then the counter reads 6 (e.g., 6 buffered frames). Accordingly, when the hardware layer 205 detects the error at 225, the hardware layer 205 may send a notification 230 to the software layer 210 indicating the number of frames (6 or 7) currently in the frame buffer. In some cases, the hardware layer 205 may identify the location (e.g., memory address) of the buffered frames. In some cases, the software layer 210 may be preprogrammed with preset locations of each buffered frame (e.g., a first preset address allocation for the first buffered frame, a second preset address allocation for the second buffered frame, etc.). Thus, the software layer 210 may determine the locations of each buffered frame based on the number of frames buffered indicated by the hardware layer 205 via notification 230 and the preset locations of each buffered frame. The software layer 210 may then process the specified number of buffered frames after receiving the notification 230.

In some examples, neither the hardware layer 205 nor the software layer 210 may experience an error at 225. Instead, after detecting and buffering the first six frames and incrementing the counter to indicate that the first 6 frames are buffered, at 220-g the hardware layer 205 may detect a seventh captured frame, buffer the detected seventh frame, and increment the counter to indicate 7 frames are buffered, then at 220-h detect an eighth captured frame, buffer the detected eighth frame, and increment the counter to indicate 8 frames are buffered.

In some examples, after buffering the detected eighth frame and incrementing the counter to indicate 8 frames are buffered, the hardware layer 205 may send a batch complete message 235 to the software layer 210. The batch complete message 235 may indicate each frame of the current batch has been buffered by the hardware layer 205. The software layer 210 may then process the buffered frames after receiving the batch complete message 235.

In some examples, the hardware layer 205 (e.g., a subsystem of hardware layer 205) may fail to send batch complete message 235 after buffering the detected eighth frame and incrementing the counter to indicate 8 frames are buffered at 220-h. After buffering the detected eighth frame and incrementing the counter to indicate 8 frames are buffered, and after batch complete message 235 fails to be generated or sent to software layer 210, the hardware layer 205 may detect a start of frames indicator 240 associated with a next batch of frames (the batch of frames after the batch of frames buffered at 220). Thus, the hardware layer 205 may detect the absence of the batch complete message 235 for the current batch of frames (e.g., frames buffered at 220) being generated or sent to the software layer 210 before detecting the start of frames indicator 240.

When the hardware layer 205 determines that the batch complete message 235 for the current batch of frames (e.g., frames buffered at 220) is not generated or sent to the software layer 210 before the hardware layer 205 detects the start of frames indicator 240, the hardware layer 205 may determine the count value of the counter for the frame buffer and send, after detecting the start of frames indicator 240, the determined count value to the software layer 210 in a notification 245. The software layer 210 may then process, based on the indicated count value, the buffered frames after receiving the notification 245.

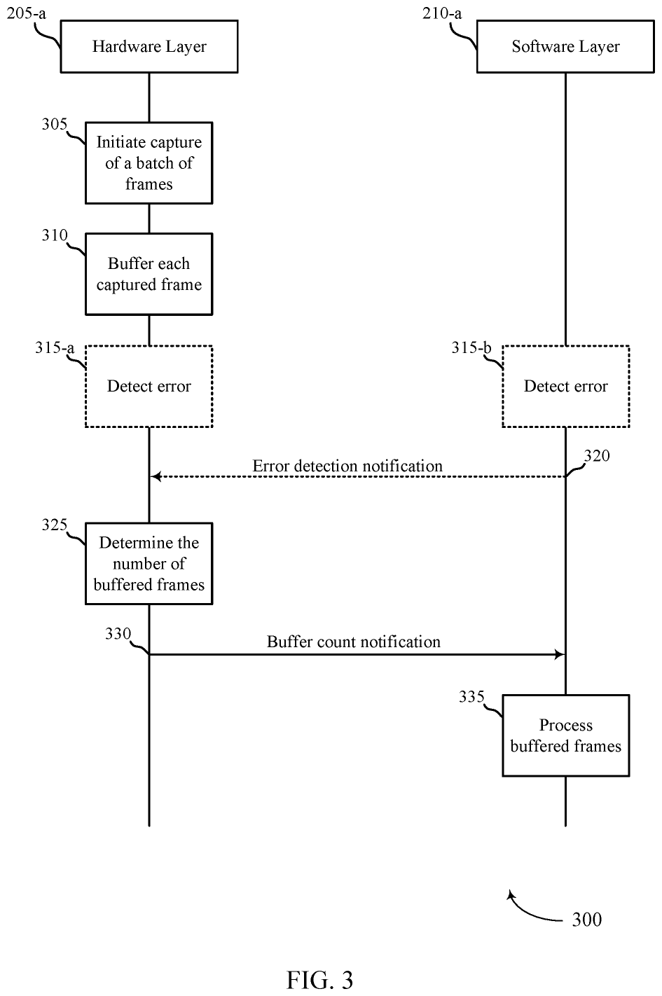

FIG. 3 illustrates an example of a process flow 300 that supports reducing dropped frames in image capturing devices in accordance with aspects of the present disclosure. In some examples, process flow 300 may implement aspects of device architecture 100. In the illustrated example, the flow diagram 300 may include hardware layer 205-a and software layer 210-a, either of which may be an example of a hardware layer 205 or a software layer 210, respectively, as described above with reference to FIG. 2.

At 305, hardware layer 205-a may initiate the capturing of a batch of frames. In some examples, the hardware layer 205-a may include a processor (e.g., processor 135, camera controller 125, image signal processor 130 of FIG. 1) and an optical sensor (e.g., sensor 110 of FIG. 1). After initiating the capturing of the batch of frames, the processor of the hardware layer 205-a may receive the batch of frames from the optical sensor of the hardware layer 205-a one frame at a time or all the frames of the batch at once.

At 310, as each frame from the batch of frames is captured, or as each batch of frames is made available to the processor, the hardware layer 205-a may buffer the captured frames in a frame buffer (e.g., frame buffer 160 of FIG. 1).

At 315-a, hardware layer 205-a may detect an error condition or at 315-b software layer 215-a may detect an error condition. In some cases, hardware layer 205-a may detect an error condition at 315-a and software layer 215-a may detect the same error condition or a different error condition at 315-b.

At 320, software layer 215-a may send an error notification message when software layer 215-a detects an error at 315-b. In some cases, the error notification message may indicate a type of error (e.g., software error, user-initiated error, etc.).

At 325, hardware layer 205-a may determine the number of frames buffered in the frame buffer. In some cases, hardware layer 205-a may include a counter that tracks the number of captured frames of a batch of frames currently buffered in the frame buffer.

At 330, hardware layer 205-a may send a buffer count notification to software layer 210-a. Among other information, the buffer count notification may indicate the number of frames the hardware layer 205-a determines are buffered in the frame buffer. In some cases, hardware layer 205-a may send the buffer count notification in response to the hardware layer 205-a detecting an error condition at 315-a or in response to the error notification message at 320, or in response to both. In some cases, the buffer count notification may include a batch complete message. For example, the hardware layer 205-a may send the buffer count notification after the hardware layer 205-a determines each of the frames of the current batch of frames is buffered.

At 335, software layer 210-a may process the buffered frames in response to receiving the buffer count notification at 330.

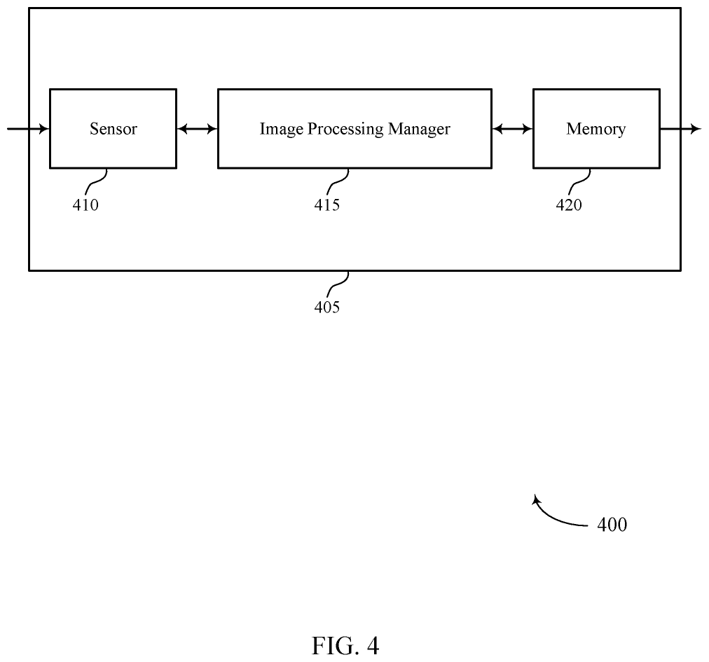

FIG. 4 shows a block diagram 400 of a device 405 that supports reducing dropped frames in image capturing devices in accordance with aspects of the present disclosure. The device 405 may be an example of aspects of a device as described herein. The device 405 may include a sensor 410, an image processing manager 415, and a memory 420. The device 405 may also include a processor. Each of these components may be in communication with one another (e.g., via one or more buses).

The sensor 410 may include or be an example of a digital imaging sensor for capturing photos and video. In some examples, sensor 410 may receive information such as packets, user data, or control information associated with various information channels. Information may be passed on from sensor 410 to other components of the device 405. Additionally or alternatively, components of device 405 used to communicate data over a wireless (e.g., or wired) link may be in communication with image processing manager 415 (e.g., via one or more buses) without passing information through sensor 410.

The image processing manager 415 may receive, from an optical sensor of the image capturing device, a batch of frames, determine, by a hardware layer or a software layer of the image capturing device, that an error condition exists in relation to the batch of frames, determine, by the hardware layer, a numerical quantity of frames of the batch of frames in a frame buffer based on determining the error condition exists, and send, by the hardware layer, the determined quantity of frames to the software layer of the image capturing device for processing by the software layer. The image processing manager 415 may be an example of aspects of the image processing manager 710 described herein.

The image processing manager 415, or its sub-components, may be implemented in hardware, code (e.g., software or firmware) executed by a processor, or any combination thereof. If implemented in code executed by a processor, the functions of the image processing manager 415, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The image processing manager 415, or its sub-components, may be physically located at various positions, including being distributed such that portions of functions are implemented at different physical locations by one or more physical components. In some examples, the image processing manager 415, or its sub-components, may be a separate and distinct component in accordance with various aspects of the present disclosure. In some examples, the image processing manager 415, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The memory 420 may store information (e.g., facial feature information) generated by other components of the device such as image processing manager 415. For example, memory 420 may store facial feature information with which to compare an output of image processing manager 415. Memory 420 may comprise one or more computer-readable storage media. Examples of memory 420 include, but are not limited to, random access memory (RAM), static RAM (SRAM), dynamic RAM (DRAM), read-only memory (ROM), electrically erasable programmable read-only memory (EEPROM), compact disc read-only memory (CD-ROM) or other optical disc storage, magnetic disc storage, or other magnetic storage devices, flash memory, or any other medium that can be used to store desired program code in the form of instructions or data structures and that can be accessed by a computer or a processor (e.g., image processing manager 415).

After the image processing manager 415 detects that an error condition exists in relation to the batch of frames, the image processing manager 415 may determine the numerical quantity of frames of a current batch of frames in a frame buffer and send the determined quantity of frames to a software layer of device 405 (e.g., a software layer of image processing manager 415) for processing by the software layer. Accordingly, the described techniques of the image processing manager 415 maintain a current frame rate and avoid frames being dropped in the device 405 when errors occur, resulting in the device 405 maintaining a current frame rate and avoiding frames being dropped, which results in an improved visual experience for end users. Furthermore, the error handling of image processing manager 415 improves the consistency in the generation and processing of images captured by device 405.

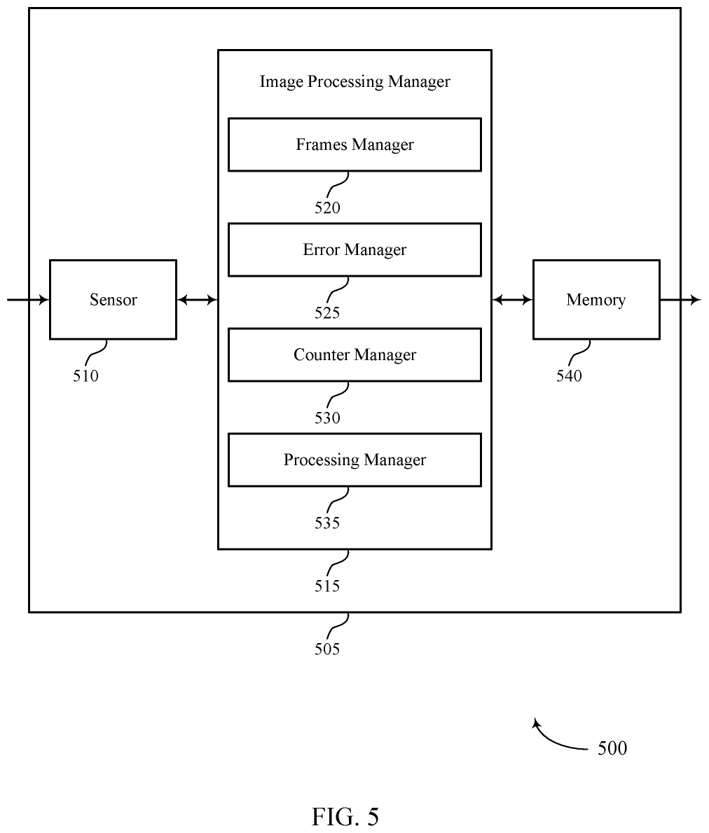

FIG. 5 shows a block diagram 500 of a device 505 that supports reducing dropped frames in image capturing devices in accordance with aspects of the present disclosure. The device 505 may be an example of aspects of a device 405 or a device 115 as described herein. The device 505 may include a sensor 510, an image processing manager 515, and a memory 540. The device 505 may also include a processor. Each of these components may be in communication with one another (e.g., via one or more buses).

The sensor 510 may include or be an example of a digital imaging sensor for taking photos and video. In some examples, sensor 510 may receive information such as packets, user data, or control information associated with various information channels. Information may be passed on to other components of the device. Additionally or alternatively, components of device 505 used to communicate data over a wireless (e.g., or wired) link may be in communication with image processing manager 515 (e.g., via one or more buses) without passing information through sensor 510.

The image processing manager 515 may be an example of aspects of the image processing manager 415 as described herein. The image processing manager 515 may include a frames manager 520, an error manager 525, a counter manager 530, and a processing manager 535. The image processing manager 515 may be an example of aspects of the image processing manager 710 described herein.

The frames manager 520 may receive, from an optical sensor of the image capturing device, a batch of frames. The error manager 525 may determine, by a hardware layer or a software layer of the image capturing device, that an error condition exists in relation to the batch of frames. The counter manager 530 may determine, by the hardware layer, a numerical quantity of frames of the batch of frames in a frame buffer based on determining the error condition exists. The processing manager 535 may send, by the hardware layer, the determined quantity of frames to the software layer of the image capturing device for processing by the software layer.

The memory 540 may store information (e.g., facial feature information) generated by other components of the device such as image processing manager 515. For example, memory 540 may store facial feature information with which to compare an output of image processing manager 515. Memory 540 may comprise one or more computer-readable storage media. Examples of memory 540 include, but are not limited to, random access memory (RAM), static RAM (SRAM), dynamic RAM (DRAM), read-only memory (ROM), electrically erasable programmable read-only memory (EEPROM), compact disc read-only memory (CD-ROM) or other optical disc storage, magnetic disc storage, or other magnetic storage devices, flash memory, or any other medium that can be used to store desired program code in the form of instructions or data structures and that can be accessed by a computer or a processor (e.g., image processing manager 515).

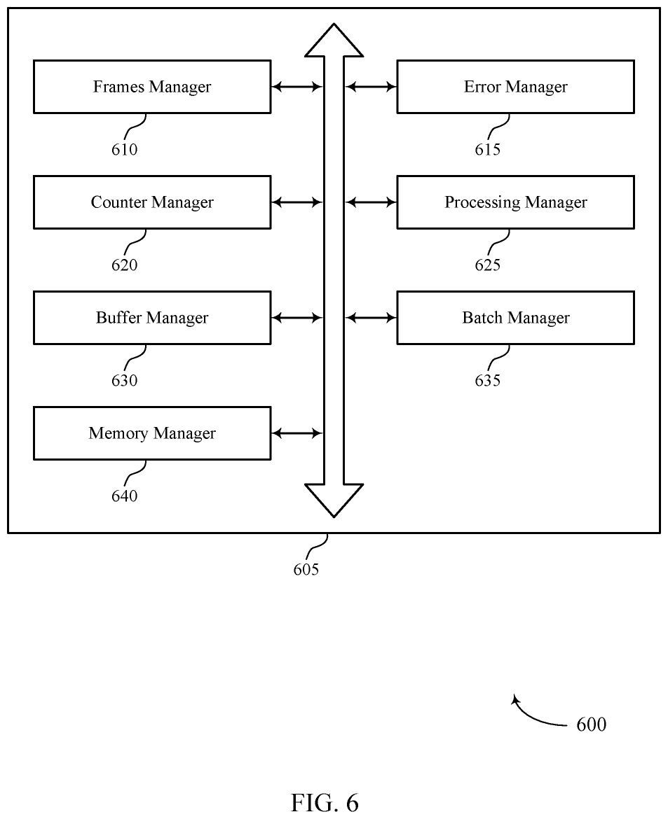

FIG. 6 shows a block diagram 600 of an image processing manager 605 that supports reducing dropped frames in image capturing devices in accordance with aspects of the present disclosure. The image processing manager 605 may be an example of aspects of an image processing manager 415, an image processing manager 515, or an image processing manager 710 described herein. The image processing manager 605 may include a frames manager 610, an error manager 615, a counter manager 620, a processing manager 625, a buffer manager 630, a batch manager 635, and a memory manager 640. Each of these modules may communicate, directly or indirectly, with one another (e.g., via one or more buses).

The frames manager 610 may receive, from an optical sensor of the image capturing device, a batch of frames. In some cases, a frame rate of the image capturing device includes at least 60 frames per second (e.g., 60 frames per second, or 90 frames per second, or 120 frames per second, or 240 frames per second, or 480 frames per second, or 720 frames per second, or 960 frames per second, or any combination thereof).

The error manager 615 may determine, by a hardware layer or a software layer of the image capturing device, that an error condition exists in relation to the batch of frames. In some cases, the hardware layer includes at least one of the optical sensor, or an image sensor, or an image processor, or an image signal processor, or a device memory, or the frame buffer, or a data storage device, or a system memory management unit, or a hardware video encoder, or a hardware video decoder, or a display device, or any combination thereof. In some cases, the software layer including at least one of a software video encoder, or a software video decoder, or an operating system, or a software application, or an image processing algorithm, or a system process, or any combination thereof.

In some examples, the error manager 615 may determine a hardware error exists in the hardware layer or a software error exists in the software layer, or any combination thereof. The counter manager 620 may determine, by the hardware layer, a numerical quantity of frames of the batch of frames in a frame buffer based on determining the error condition exists. The processing manager 625 may send, by the hardware layer, the determined quantity of frames to the software layer of the image capturing device for processing by the software layer.

The buffer manager 630 may determine a frame of the batch of frames is buffered in the frame buffer. In some examples, the buffer manager 630 may increment a counter of the image capturing device based on the frame being buffered in the frame buffer, where the counter indicates a quantity of frames buffered in the frame buffer since initiating the batch of frames. In some examples, the buffer manager 630 may determine a count value of the counter based on determining the hardware error exists in the hardware layer or determining the software error exists in the software layer, or both. In some cases, the initiating of the batch of frames is indicated by a start of frames indicator for the batch of frames. In some cases, the counter includes a dedicated hardware register.

The batch manager 635 may detect an absence of a batch complete message for the batch of frames before a start of frames indicator for a second batch of frames is detected, where the batch of frames is a first batch of frames, and where the second batch of frames is directly subsequent to the batch of frames.

In some examples, the batch manager 635 may determine a count value of the counter of the image capturing device based on detecting the absence of the batch complete message for the batch of frames before detecting the start of frames indicator for the second batch of frames.

The memory manager 640 may determine a range of addresses for frames associated with the numerical quantity of frames of the batch of frames in the frame buffer or an address for each frame associated with the numerical quantity of frames of the batch of frames in the frame buffer. In some examples, the memory manager 640 may provide the range of addresses for the frames or the address for each frame to the software layer.

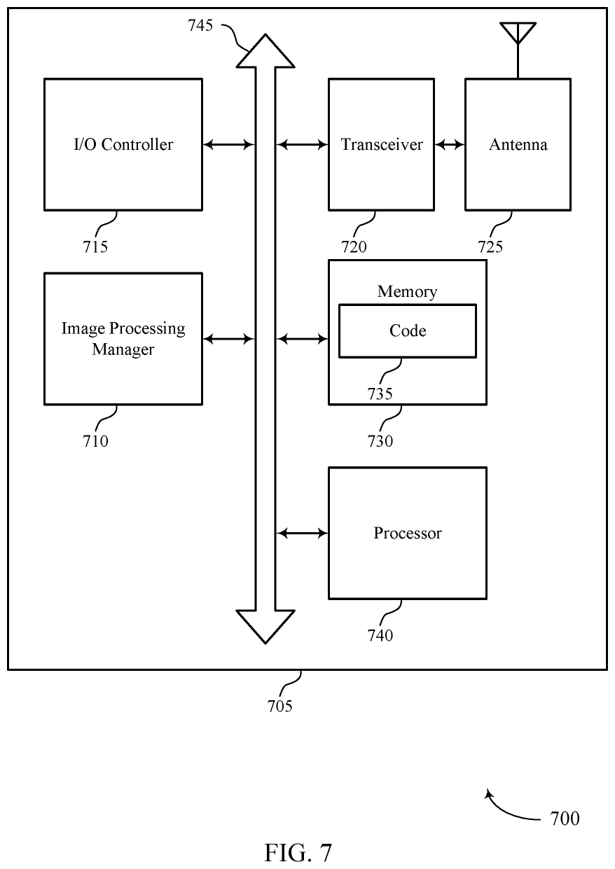

FIG. 7 shows a diagram of a system 700 including a device 705 that supports reducing dropped frames in image capturing devices in accordance with aspects of the present disclosure. The device 705 may be an example of or include the components of device 405, device 505, or a device as described herein. The device 705 may include components for bi-directional voice and data communications including components for transmitting and receiving communications, including an image processing manager 710, an I/O controller 715, a transceiver 720, an antenna 725, memory 730, a processor 740, and a coding manager 750. These components may be in electronic communication via one or more buses (e.g., bus 745).

The image processing manager 710 may receive, from an optical sensor of the image capturing device, a batch of frames, determine, by a hardware layer or a software layer of the image capturing device, that an error condition exists in relation to the batch of frames, determine, by the hardware layer, a numerical quantity of frames of the batch of frames in a frame buffer based on determining the error condition exists, and send, by the hardware layer, the determined quantity of frames to the software layer of the image capturing device for processing by the software layer.

The I/O controller 715 may manage input and output signals for the device 705. The I/O controller 715 may also manage peripherals not integrated into the device 705. In some cases, the I/O controller 715 may represent a physical connection or port to an external peripheral. In some cases, the I/O controller 715 may utilize an operating system such as iOS®, ANDROID®, MS-DOS®, MS-WINDOWS®, OS/2®, UNIX®, LINUX®, or another known operating system. In other cases, the I/O controller 715 may represent or interact with a modem, a keyboard, a mouse, a touchscreen, or a similar device. In some cases, the I/O controller 715 may be implemented as part of a processor. In some cases, a user may interact with the device 705 via the I/O controller 715 or via hardware components controlled by the I/O controller 715.

The transceiver 720 may communicate bi-directionally, via one or more antennas, wired, or wireless links as described above. For example, the transceiver 720 may represent a wireless transceiver and may communicate bi-directionally with another wireless transceiver. The transceiver 720 may also include a modem to modulate the packets and provide the modulated packets to the antennas for transmission, and to demodulate packets received from the antennas.

In some cases, the wireless device may include a single antenna 725. However, in some cases the device may have more than one antenna 725, which may be capable of concurrently transmitting or receiving multiple wireless transmissions.

The memory 730 may include RAM and ROM. The memory 730 may store computer-readable, computer-executable code 735 including instructions that, when executed, cause the processor to perform various functions described herein. In some cases, the memory 730 may contain, among other things, a BIOS which may control basic hardware or software operation such as the interaction with peripheral components or devices.

The processor 740 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In other cases, a memory controller may be integrated into the processor 740. The processor 740 may be configured to execute computer-readable instructions stored in a memory (e.g., the memory 730) to cause the device 705 to perform various functions (e.g., functions or tasks supporting reducing dropped frames in image capturing devices).

The code 735 may include instructions to implement aspects of the present disclosure, including instructions to support reducing dropped frames in an image capturing device. The code 735 may be stored in a non-transitory computer-readable medium such as system memory or other type of memory. In some cases, the code 735 may not be directly executable by the processor 740 but may cause a computer (e.g., when compiled and executed) to perform functions described herein.

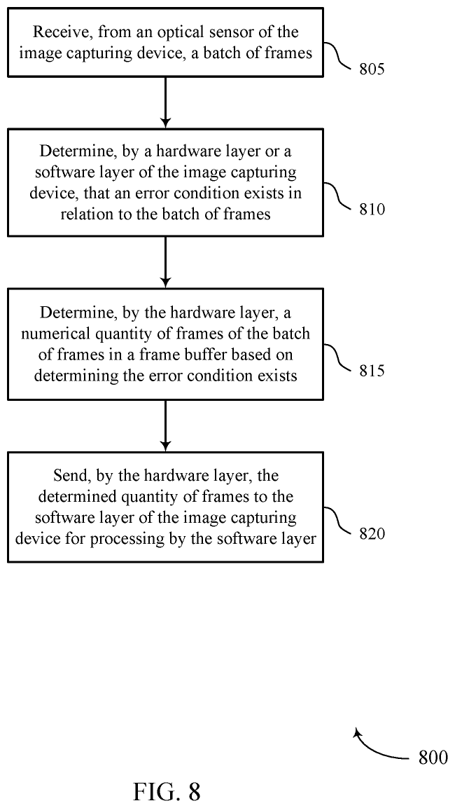

FIG. 8 shows a flowchart illustrating a method 800 that supports reducing dropped frames in image capturing devices in accordance with aspects of the present disclosure. The operations of method 800 may be implemented by a device or its components as described herein. For example, the operations of method 800 may be performed by an image processing manager as described with reference to FIGS. 4 through 7. In some examples, a device may execute a set of instructions to control the functional elements of the device to perform the functions described below. Additionally or alternatively, a device may perform aspects of the functions described below using special-purpose hardware.

At 805, the device may receive, from an optical sensor of the image capturing device, a batch of frames. The operations of 805 may be performed according to the methods described herein. In some examples, aspects of the operations of 805 may be performed by a frames manager as described with reference to FIGS. 4 through 7.

At 810, the device may determine, by a hardware layer or a software layer of the image capturing device, that an error condition exists in relation to the batch of frames. The operations of 810 may be performed according to the methods described herein. In some examples, aspects of the operations of 810 may be performed by an error manager as described with reference to FIGS. 4 through 7.

At 815, the device may determine, by the hardware layer, a numerical quantity of frames of the batch of frames in a frame buffer based on determining the error condition exists. The operations of 815 may be performed according to the methods described herein. In some examples, aspects of the operations of 815 may be performed by a counter manager as described with reference to FIGS. 4 through 7.

At 820, the device may send, by the hardware layer, the determined quantity of frames to the software layer of the image capturing device for processing by the software layer. The operations of 820 may be performed according to the methods described herein. In some examples, aspects of the operations of 820 may be performed by a processing manager as described with reference to FIGS. 4 through 7.

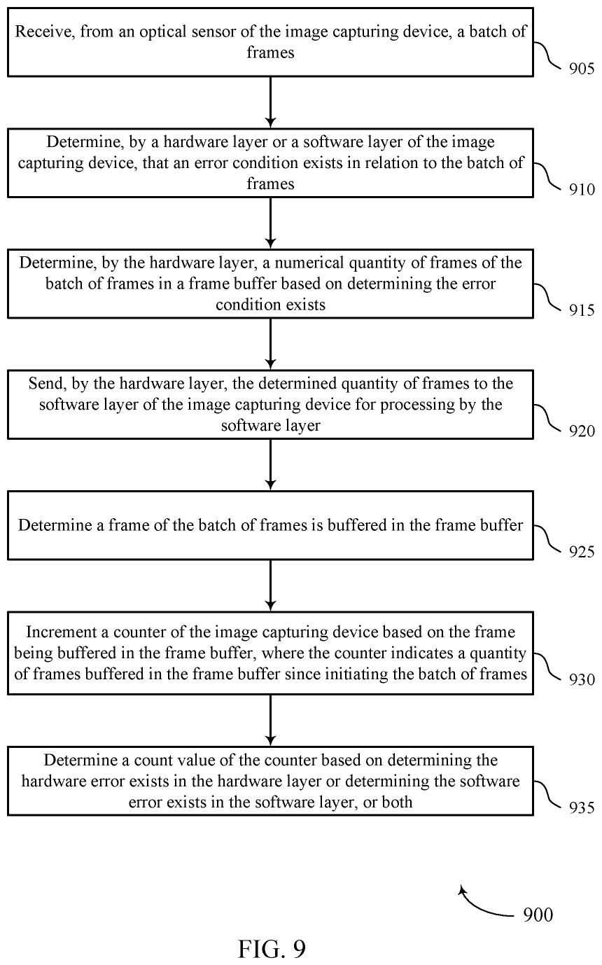

FIG. 9 shows a flowchart illustrating a method 900 that supports reducing dropped frames in image capturing devices in accordance with aspects of the present disclosure. The operations of method 900 may be implemented by a device or its components as described herein. For example, the operations of method 900 may be performed by an image processing manager as described with reference to FIGS. 4 through 7. In some examples, a device may execute a set of instructions to control the functional elements of the device to perform the functions described below. Additionally or alternatively, a device may perform aspects of the functions described below using special-purpose hardware.

At 905, the device may receive, from an optical sensor of the image capturing device, a batch of frames. The operations of 905 may be performed according to the methods described herein. In some examples, aspects of the operations of 905 may be performed by a frames manager as described with reference to FIGS. 4 through 7.

At 910, the device may determine, by a hardware layer or a software layer of the image capturing device, that an error condition exists in relation to the batch of frames. The operations of 910 may be performed according to the methods described herein. In some examples, aspects of the operations of 910 may be performed by an error manager as described with reference to FIGS. 4 through 7.

At 915, the device may determine, by the hardware layer, a numerical quantity of frames of the batch of frames in a frame buffer based on determining the error condition exists. The operations of 915 may be performed according to the methods described herein. In some examples, aspects of the operations of 915 may be performed by a counter manager as described with reference to FIGS. 4 through 7.

At 920, the device may send, by the hardware layer, the determined quantity of frames to the software layer of the image capturing device for processing by the software layer. The operations of 920 may be performed according to the methods described herein. In some examples, aspects of the operations of 920 may be performed by a processing manager as described with reference to FIGS. 4 through 7.

At 925, the device may determine a frame of the batch of frames is buffered in the frame buffer. The operations of 925 may be performed according to the methods described herein. In some examples, aspects of the operations of 925 may be performed by a buffer manager as described with reference to FIGS. 4 through 7.

At 930, the device may increment a counter of the image capturing device based on the frame being buffered in the frame buffer, where the counter indicates a quantity of frames buffered in the frame buffer since initiating the batch of frames. The operations of 930 may be performed according to the methods described herein. In some examples, aspects of the operations of 930 may be performed by a buffer manager as described with reference to FIGS. 4 through 7.

At 935, the device may determine a count value of the counter based on determining the hardware error exists in the hardware layer or determining the software error exists in the software layer, or both. The operations of 935 may be performed according to the methods described herein. In some examples, aspects of the operations of 935 may be performed by a buffer manager as described with reference to FIGS. 4 through 7.

It should be noted that the methods described herein describe possible implementations, and that the operations and the steps may be rearranged or otherwise modified and that other implementations are possible. Further, aspects from two or more of the methods may be combined.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA, or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for reducing dropped frames in an image capturing device, the method comprising:
receiving, from an optical sensor of the image capturing device, a batch of frames;
determining, by a hardware layer or a software layer of the image capturing device, that an error condition exists in relation to the batch of frames;
determining, by the hardware layer, a numerical quantity of frames of the batch of frames in a frame buffer based at least in part on determining the error condition exists; and
sending, by the hardware layer, the determined quantity of frames to the software layer of the image capturing device for processing by the software layer.

2. The method of claim 1, further comprising:
determining a frame of the batch of frames is buffered in the frame buffer; and
incrementing a counter of the image capturing device based at least in part on the frame being buffered in the frame buffer, wherein the counter indicates a quantity of frames buffered in the frame buffer since initiating the batch of frames.

3. The method of claim 2, wherein determining the quantity of frames comprises:
determining a count value of the counter based at least in part on determining the hardware error exists in the hardware layer or determining the software error exists in the software layer, or both.

4. The method of claim 3, wherein the initiating of the batch of frames is indicated by a start of frames indicator for the batch of frames.

5. The method of claim 2, wherein the counter comprises a dedicated hardware register.

6. The method of claim 2, wherein determining the error condition exists comprises:
detecting an absence of a batch complete message for the batch of frames before a start of frames indicator for a second batch of frames is detected, wherein the batch of frames is a first batch of frames, and wherein the second batch of frames is directly subsequent to the batch of frames.

7. The method of claim 6, wherein determining the quantity of frames comprises:
determining a count value of the counter of the image capturing device based at least in part on detecting the absence of the batch complete message for the batch of frames before detecting the start of frames indicator for the second batch of frames.

8. The method of claim 1, wherein sending the determined quantity of frames to the software layer comprises:
determining a range of addresses for frames associated with the numerical quantity of frames of the batch of frames in the frame buffer or an address for each frame associated with the numerical quantity of frames of the batch of frames in the frame buffer; and
providing the range of addresses for the frames or the address for each frame to the software layer.

9. The method of claim 1, wherein a frame rate of the image capturing device comprises at least one of 60 frames per second, or 90 frames per second, or 120 frames per second, or 240 frames per second, or 480 frames per second, or 720 frames per second, or 960 frames per second.

10. The method of claim 1, wherein the hardware layer comprises at least one of the optical sensor, or an image sensor, or an image processor, or an image signal processor, or a device memory, or the frame buffer, or a data storage device, or a system memory management unit, or a hardware video encoder, or a hardware video decoder, or a display device, or any combination thereof.

11. The method of claim 1, wherein the software layer comprising at least one of a software video encoder, or a software video decoder, or an operating system, or a software application, or an image processing algorithm, or a system process, or any combination thereof.

12. The method of claim 1, wherein determining the error condition exists comprises:
determining a hardware error exists in the hardware layer or a software error exists in the software layer, or any combination thereof.

13. An apparatus for reducing dropped frames in an image capturing device, the method:
a processor,
memory coupled with the processor; and
instructions stored in the memory and executable by the processor to cause the apparatus to:
receive, from an optical sensor of the image capturing device, a batch of frames;
determine, by a hardware layer or a software layer of the image capturing device, that an error condition exists in relation to the batch of frames;
determine, by the hardware layer, a numerical quantity of frames of the batch of frames in a frame buffer based at least in part on determining the error condition exists; and
send, by the hardware layer, the determined quantity of frames to the software layer of the image capturing device for processing by the software layer.

14. The apparatus of claim 13, wherein the instructions are further executable by the processor to cause the apparatus to:
determine a frame of the batch of frames is buffered in the frame buffer; and
increment a counter of the image capturing device based at least in part on the frame being buffered in the frame buffer, wherein the counter indicates a quantity of frames buffered in the frame buffer since initiating the batch of frames.

15. The apparatus of claim 14, wherein the instructions to determine the quantity of frames are executable by the processor to cause the apparatus to:
determine a count value of the counter based at least in part on determining the hardware error exists in the hardware layer or determining the software error exists in the software layer, or both.

16. The apparatus of claim 15, wherein the initiating of the batch of frames is indicated by a start of frames indicator for the batch of frames.

17. The apparatus of claim 14, wherein the counter comprises a dedicated hardware register.

18. The apparatus of claim 14, wherein the instructions to determine the error condition exists are executable by the processor to cause the apparatus to:
detect an absence of a batch complete message for the batch of frames before a start of frames indicator for a second batch of frames is detected, wherein the batch of frames is a first batch of frames, and wherein the second batch of frames is directly subsequent to the batch of frames.

19. A non-transitory computer-readable medium storing code for reducing dropped frames in an image capturing device, the method comprising, the code comprising instructions executable by a processor to:
receive, from an optical sensor of the image capturing device, a batch of frames;
determine, by a hardware layer or a software layer of the image capturing device, that an error condition exists in relation to the batch of frames;
determine, by the hardware layer, a numerical quantity of frames of the batch of frames in a frame buffer based at least in part on determining the error condition exists; and
send, by the hardware layer, the determined quantity of frames to the software layer of the image capturing device for processing by the software layer.

20. The non-transitory computer-readable medium of claim 19, wherein the instructions are further executable to:
determine a frame of the batch of frames is buffered in the frame buffer; and
increment a counter of the image capturing device based at least in part on the frame being buffered in the frame buffer, wherein the counter indicates a quantity of frames buffered in the frame buffer since initiating the batch of frames.
